(19) United States
(12) Patent Application Publication
(10) Pub. No.: US 2010/0161841 A1
(43) Pub. Date: Jun. 24, 2010

(54) DRIVE ICON DISPLAY DEVICE, METHOD, AND SYSTEM

(76) Inventors: Katsumi AKAGI, Osaka (JP); Yoshiyuki Uchiyama, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/484,641

(22) Filed: Jun. 15, 2009

(30) Foreign Application Priority Data
Jun. 16, 2008 (JP) 2008-156185

(51) Int. Cl. G06F 3/00

(52) U.S. Cl. 710/17

(57) ABSTRACT

A drive icon display device of the present invention includes: a drive connection detecting section for detecting that a drive is connected; a drive identification information obtaining section for obtaining drive identification information about the drive; a drive identification information determining section for determining whether or not the drive stores the dedicated icon; an icon obtaining section for, when it is determined that the drive stores the dedicated icon, obtaining the dedicated icon from the drive, and for, when it is determined that the drive does not store the dedicated icon, obtaining a predetermined icon stored in advance in the drive icon display device; and a display section for displaying on a screen one of the obtained dedicated icon and the obtained predetermined icon.

### BACKGROUND OF THE INVENTION

1. Field of the Invention

The present invention relates to a drive icon display device for recognizing a drive and displaying an icon of the drive, and more particularly, to a drive icon display device, a drive icon display method, and a drive icon display system, which are capable of displaying an optimum icon for a drive connected to the drive icon display device.

2. Description of the Background Art

Generally, a drive icon display device recognizes a drive which is connected thereto in a connection form such as IDE, SATA, SCSI, USB, or a network, for example. Examples of such a drive are a hard disk drive (HDD), a recordable DVD/BD drive, a USB memory, a DVD/BD recorder, a digital video camera, a digital still camera, and the like. When the drive icon display device recognizes such a drive, the drive icon display device displays on the screen an icon corresponding to the drive from among icons stored in advance in the drive icon display device. For example, the drive icon display device displays on the screen an icon which indicates a local disk, a DVD-RAM, a removable medium, or the like, in accordance with a type such as an internal hard disk drive, a recordable DVD/BD drive, or a USB memory.

The icon corresponding to the drive connected to the drive icon display device is displayed on the screen of the drive icon display device. Therefore, when operating the drive connected to the drive icon display device, a user can easily specify the drive to be operated. The user operates the drive connected to the drive icon display device by operating the icon of the drive to be operated.

In addition, when an external device, an expansion card, or the like is connected to the drive icon display device, hardware, firmware, a driver, an operating system, an application, and the like automatically work in a coordinated manner, and automatically perform install and configuration of the device, that is, a so-called plug-and-play operation is performed.

FIG. 8 is a sequence diagram showing a plug-and-play operation performed between a conventional drive icon display device and a drive. In FIG. 8, in order to obtain drive identification information which indicates the type of the connected drive, the drive icon display device executes an Inquiry command and thereby transmits a drive identification information request to the drive. The drive receives the drive identification information request from the drive icon display device, and responds to the drive icon display device with the drive identification information about the drive. Thus, the drive icon display device obtains the drive identification information from the connected drive. The drive icon display device displays on the screen an icon corresponding to the obtained drive identification information from among icons stored in advance in the drive icon display device.

However, the icons stored in advance in the drive icon display device are icons which are set in the operating system or the like, and the drive icon display device does not necessarily store icons corresponding to all the drives to be connected to the drive icon display device. Therefore, it may occur that the drive icon display device cannot display on the screen an optimum icon corresponding to a drive connected to the drive icon display device.

For example, a recordable DVD/BD drive functions as a removable and CD-ROM type drive. When the recordable DVD/BD drive is connected to the drive icon display device, the recordable DVD/BD drive receives the drive identification information request from the drive icon display device, and responds to the drive icon display device with drive identification information which indicates that the recordable DVD/BD drive is of CD-ROM type. Accordingly, the drive icon display device displays on the screen an icon which represents a CD-ROM drive for the recordable DVD/BD drive.

Conventionally, a drive which is to be connected to the drive icon display device is only assumed to have a single function, and the drive icon display device stores, in advance, icons corresponding to the individual functions. Therefore, even when a drive, as presently used, having a plurality of functions is connected to the drive icon display device, there is displayed an icon corresponding to a representative type among the types of the plurality of functions of the connected drive.

In addition, also in a case where a new type of drive is developed in the future, an icon corresponding to the new type of drive is not set in the operating system included in the drive icon display device, and therefore it is impossible to display an optimum icon which represents the new type of drive.

Further, even if the drive icon display device stores an icon corresponding to a drive connected to the drive icon display device, when a plurality of drives having identical functions are connected to the drive icon display device or when a drive having a plurality of identical functions is connected to the drive icon display device, the drive icon display device displays on the screen a plurality of identical icons corresponding to the identical functions. Therefore, there is a problem that a user cannot easily specify a drive to be operated. Note that a method in which a plurality of icons are grouped to be managed is disclosed a method enabling a user to easily specify any particular icons (e.g., see Japanese Laid-Open Patent Publication No. 2000-305696).

### SUMMARY OF THE INVENTION

Therefore, an object of the present invention is to provide a drive icon display device which displays on the screen an optimum icon corresponding to a drive connected to the drive icon display device, and which enables a user to easily specify a drive to be operated.

In order to achieve the above object, a drive icon display device of the present invention recognizes a drive and displays an icon of the drive, and includes: a drive connection detecting section for detecting that the drive is connected; a drive identification information obtaining section for obtaining drive identification information which indicates a type of the drive and contains icon storage information that indicates whether or not the drive stores a dedicated icon which is a symbol representing the drive; a drive identification information determining section for determining, based on the icon storage information, whether or not the drive stores the dedicated icon; an icon obtaining section for, when it is determined that the drive stores the dedicated icon, obtaining the dedicated icon from the drive, and for, when it is determined that the drive does not store the dedicated icon, obtaining a predetermined icon corresponding to the type of the drive from among icons stored in advance in the drive icon display device; and a display section for displaying on a screen one of the obtained dedicated icon and the obtained predetermined icon.

Preferably, the drive icon display device further includes: an icon confirmation section for causing a user to confirm whether or not to employ the obtained dedicated icon; and an icon creating section for, based on the result of the confirmation in the icon confirmation section, when the dedicated icon is not employed, creating a new dedicated icon different from the dedicated icon, and the display section displays on the screen the new dedicated icon instead of the dedicated icon.

Further, preferably, the drive icon display device provides the created new dedicated icon to the drive.

In order to achieve the above object, a drive icon display system of the present invention includes a drive and a drive icon display device for recognizing the drive and displaying an icon of the drive, and the drive includes: a memory for storing drive identification information which indicates a type of the drive and contains icon storage information that indicates whether or not the drive stores a dedicated icon which is a symbol representing the drive, and for storing the dedicated icon; a drive identification information extracting section for, based on a request for drive identification information from the drive icon display device, extracting from the memory the drive identification information about the drive; and a dedicated icon extracting section for, based on a request for a dedicated icon from the drive icon display device, extracting from the memory the dedicated icon for the drive, and the drive icon display device includes: a drive connection detecting section for detecting that the drive is connected; a drive identification information obtaining section for making a request to the drive for the drive identification information, and obtaining the drive identification information; a drive identification information determining section for determining, based on the icon storage information, whether or not the drive stores the dedicated icon; an icon obtaining section for, when it is determined that the drive stores the dedicated icon, making a request to the drive for the dedicated icon and obtaining the dedicated icon, and for, when it is determined that the drive does not store the dedicated icon, obtaining a predetermined icon corresponding to the type of the drive from among icons stored in advance in the drive icon display device; and a display section for displaying on a screen one of the obtained dedicated icon and the obtained predetermined icon.

Preferably, the drive icon display device further includes: an icon confirmation section for causing a user to confirm whether or not to employ the obtained dedicated icon; and an icon creating section for, based on the result of the confirmation in the icon confirmation section, when the dedicated icon is not employed, creating a new dedicated icon different from the dedicated icon, and the display section displays on the screen the new dedicated icon instead of the dedicated icon.

Further, preferably, the drive icon display device provides the created new dedicated icon to the drive, and the drive stores in the memory the new dedicated icon provided by the drive icon display device.

Processing performed by the components of the above-described drive icon display device and drive icon display system can be considered as a drive icon display method of executing processing including a series of steps. The method is provided in the form of a program which causes a computer to execute the processing including a series of steps. The program may be introduced into the computer in the form where the program is stored in a computer-readable storage medium.

As described above, by using the present invention, there can be realized a drive icon display device which displays on the screen an optimum icon corresponding to a drive connected to the drive icon display device, and which enables a user to easily specify a drive to be operated.

The present invention is useful for an application of a drive icon display device, an HDD, a recordable DVD/BD drive, a USB memory, a DVD/BD recorder, a digital video camera, a digital still camera, and the like.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a drive icon display system 1000 according to a first embodiment of the present invention;

FIG. 2 is a flowchart showing a drive icon display method 100 according to the first embodiment of the present invention;

FIG. 3 is a sequence diagram showing a plug-and-play operation performed between a drive icon display device 1100 and a drive 1200 according to the first embodiment of the present invention;

FIG. 4 shows a data format, of an Inquiry command, according to the first embodiment of the present invention;

FIG. 5 shows a drive icon display system 2000 according to a second embodiment of the present invention;

FIG. 6 is a flowchart showing a drive icon display method 200 according to the second embodiment of the present invention;

FIG. 7 is a flowchart showing a drive icon display method 300 for displaying a new dedicated icon as a dedicated icon for a drive; and

FIG. 8 is a sequence diagram showing a plug-and-play operation performed between a conventional drive icon display device and a drive.

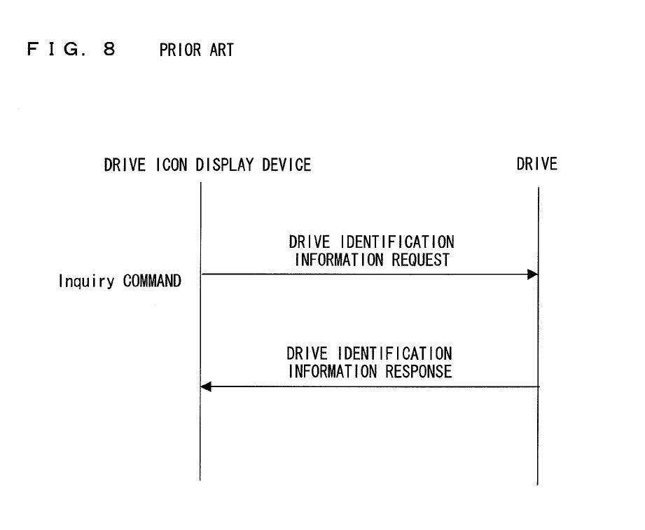

### DESCRIPTION OF THE PREFERRED EMBODIMENTS

Hereinafter, embodiments of the present invention will be described in detail with reference to the drawings.

### First Embodiment

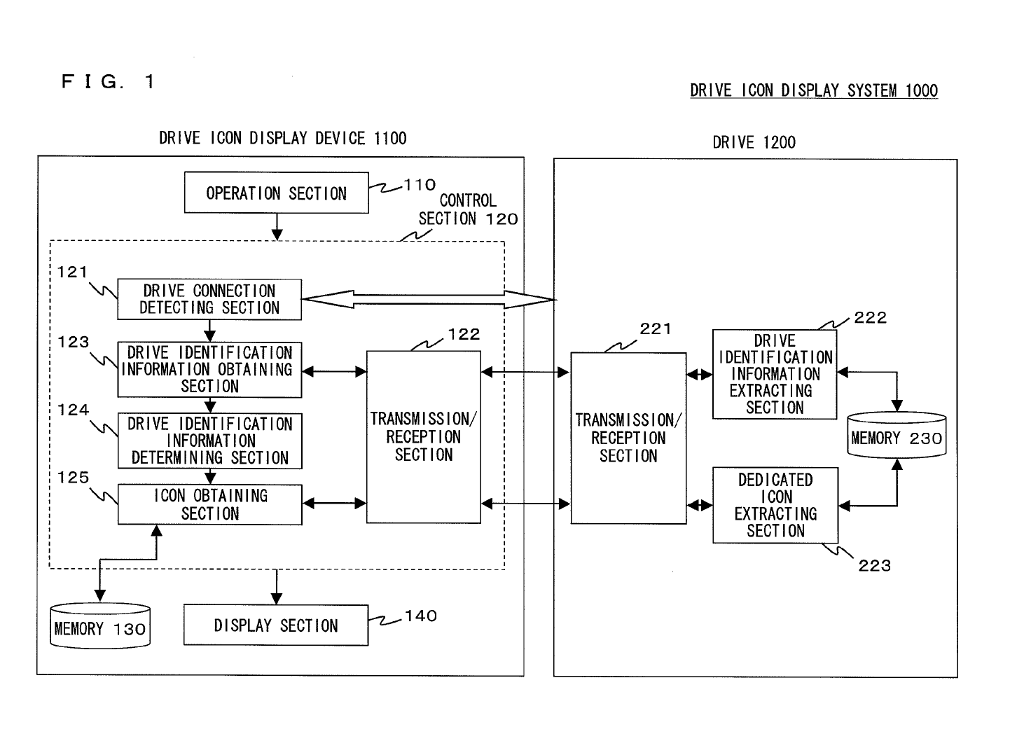

FIG. 1 shows a drive icon display system 1000 according to a first embodiment of the present invention. In FIG. 1, the drive icon display system 1000 includes a drive icon display device 1100 and a drive 1200.

The drive icon display device 1100 includes an operation section 110, a control section 120, a memory 130, and a display section 140. Further, the control section 120 includes a drive connection detecting section 121, a transmission/reception section 122, a drive identification information obtaining section 123, a drive identification information determining section 124, and an icon obtaining section 125. The control section 120 controls each function section described above, in accordance with: an instruction from the operation section 110; a request to and a response from the drive 1200; cooperation with the memory 130 and the display section 140; and the like.

The drive 1200 includes a transmission/reception section 221, a drive identification information extracting section 222, a dedicated icon extracting section 223, and a memory 230.

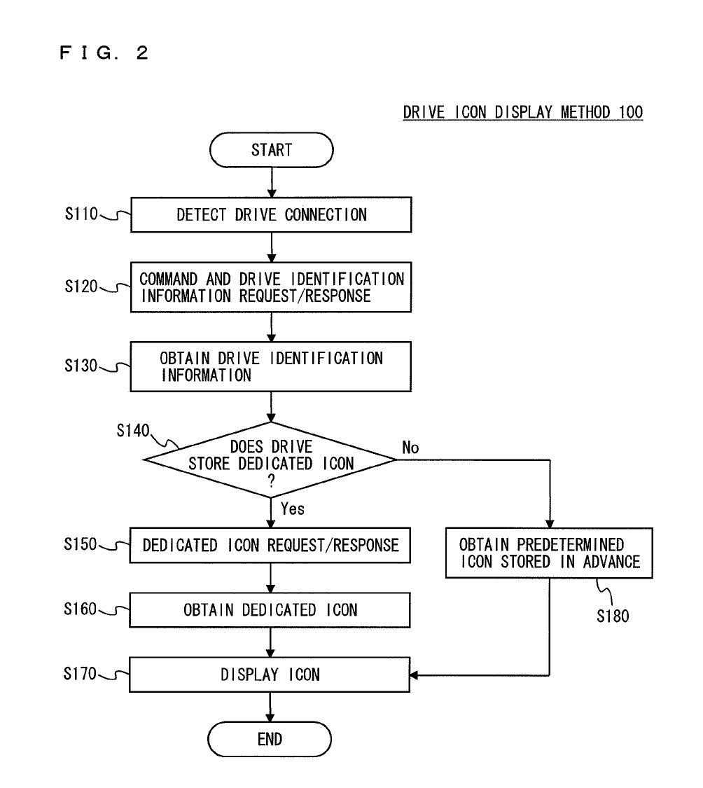

FIG. 2 is a flowchart showing a drive icon display method 100 according to the first embodiment of the present invention. In FIG. 2, the drive icon display device 1100 executes steps S110 to S180 as described below while inquiring the drive 1200.

First, a user operates the operation section 110 of the drive icon display device 1100 so as to cause the drive icon display device 1100 to execute the drive icon display method 100. Typically, when a user operates the operation section 110 of the drive icon display device 1100 and thereby starts the drive icon display device 1100, the execution of the drive icon display method 100 is started.

In step S110, the drive connection detecting section 121 detects that the drive 1200 is connected to the drive icon display device 1100.

Next, the drive icon display device 1100 obtains drive identification information about the detected drive 1200 in accordance with the following process.

In step S120, the transmission/reception section 122 executes an Inquiry command and thereby transmits a drive identification information request to the connected drive 1200. The transmission/reception section 122 receives, from the drive 1200, a drive identification information response to the drive identification information request.

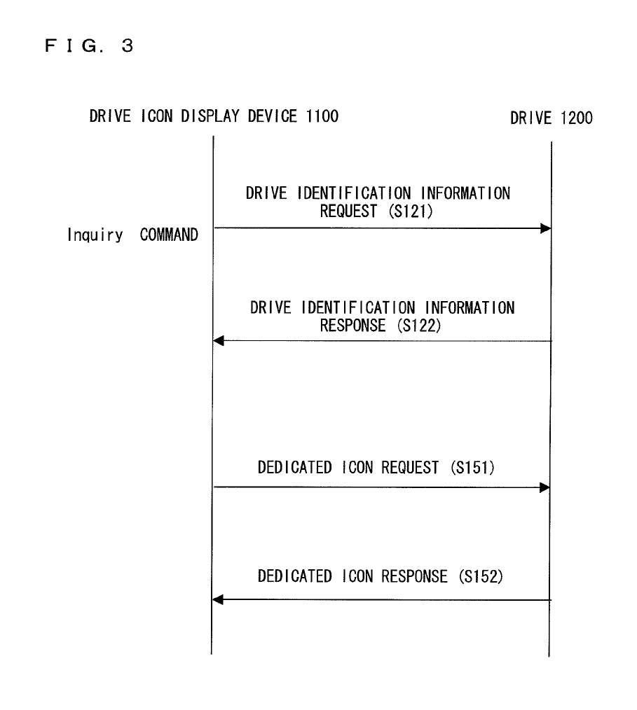

Here, the drive identification information request/response which is performed between the drive icon display device 1100 and the drive 1200, is described in detail. FIG. 3 is a sequence diagram showing a plug-and-play operation performed between the drive icon display device 1100 and the drive 1200 according to the first embodiment of the present invention. In FIG. 3, the drive icon display device 1100 executes the Inquiry command to transmit the drive identification information request to the connected drive 1200 (step S121). In the drive 1200, the transmission/reception section 221 receives the drive identification information request (step S121), and the drive identification information extracting section 222 extracts the drive identification information stored in the memory 230 of the drive 1200. The drive identification information about the drive 1200 contains information which indicates the type of the drive, e.g., a recordable DVD/BD drive or the like.

The drive identification information also contains icon storage information which indicates whether or not a dedicated icon for the drive 1200 is stored in the memory 230 of the drive 1200. Wherein, the dedicated icon for the drive 1200 is an icon which is appropriate as a symbol representing the drive 1200. The dedicated icon may be stored in advance in the drive by the manufacturer when the drive is manufactured, or may be created by a user and then stored in the drive.

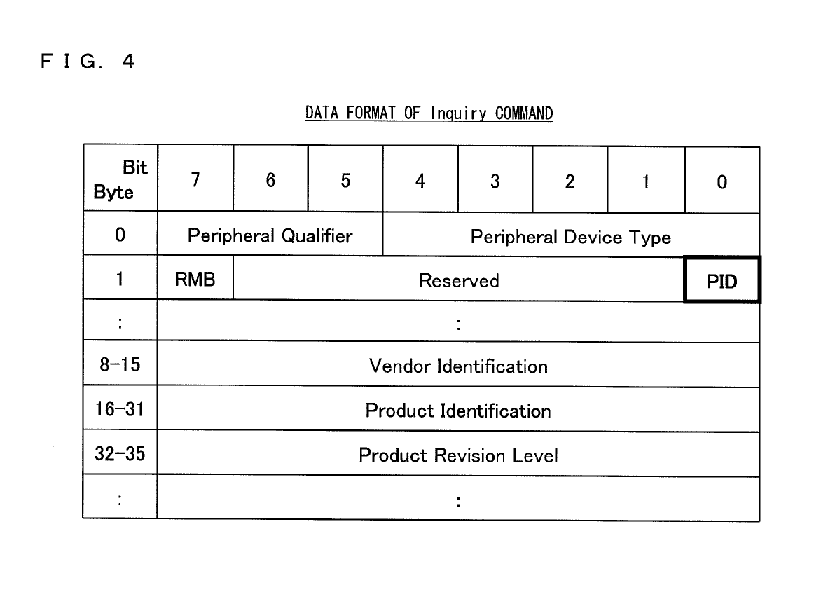

FIG. 4 shows a data format of the Inquiry command according to the first embodiment of the present invention. If the dedicated icon for the drive 1200 is stored in the memory 230 of the drive 1200, “1” is set in “PID” which indicates icon storage information and which is present at the location of Byte “1”, Bit “0”. Alternatively, when the drive identification information extracting section 222 of the drive 1200 extracts the drive identification information, it may be recognized that the dedicated icon for the drive 1200 is stored in the memory 230 of the drive 1200, and then “1” may be set in “PID”.

The area for indicating the icon storage information is not limited to the location of Byte “1”, Bit “0”, since the data format shown in FIG. 4 is exemplary. Other locations can be used as the area for indicating the icon storage information as long as the positions are not reserved areas.

Thus, the drive identification information extracting section 222 of the drive 1200 extracts the drive identification information which contains the icon storage information about the drive 1200, and the transmission/reception section 221 transmits, to the drive icon display device 1100, the drive identification information response (step S122).

In step S130, the drive identification information obtaining section 123 obtains the drive identification information about the drive 1200 received in step S120.

In step S140, the drive identification information determining section 124 determines the drive identification information about the drive 1200 obtained in step S130. Specifically, the drive identification information determining section 124 refers to “PID”, in the data format of the Inquiry command shown in FIG. 4, which indicates the icon storage information.

If “PID” is not “1”, the drive identification information determining section 124 determines that the dedicated icon for the drive 1200 is not stored in the drive 1200, and then processing proceeds to step S180 (No in step S140). In step S180, based on the drive identification information about the drive 1200 obtained in step S130, the icon obtaining section 125 obtains a predetermined icon corresponding to the type of the drive 1200 from among icons which are stored in advance in the memory 130 of the drive icon display device 1100, and then processing proceeds to step S170. In step S170, the display section 140 displays on the screen the predetermined icon obtained in step S180.

On the other hand, if “PID” is “1”, the drive identification information determining section 124 determines that the dedicated icon for the drive 1200 is stored in the drive 1200, and the icon obtaining section 125 obtains the dedicated icon for the drive 1200 in accordance with the following process (Yes in step S140).

In step S150, the transmission/reception section 122 transmits a dedicated icon request to the connected drive 1200. The transmission/reception section 122 receives from the drive 1200 a dedicated icon response which is a response to the dedicated icon request.

Here, the dedicated icon request/response which is performed between the drive icon display device 1100 and the drive 1200, is described in detail. In FIG. 3, the drive icon display device 1100 transmits the dedicated icon request to the drive 1200 (step S151). In the drive 1200, the transmission/reception section 221 receives the dedicated icon request (step S151), and the dedicated icon extracting section 223 extracts the dedicated icon, for the drive 1200, which is stored in the memory 230 of the drive 1200.

Thus, in the drive 1200, the dedicated icon extracting section 223 extracts the dedicated icon for the drive 1200, and the transmission/reception section 221 transmits the extracted dedicated icon as the dedicated icon response, to the drive icon display device 1100 (step S152).

In step S160, the icon obtaining section 125 obtains the dedicated icon, for the drive 1200, received from the drive 1200 in step S150.

In step S170, the display section 140 displays on the screen the dedicated icon, for the drive 1200, obtained in step S160.

Thus, if the drive 1200 stores the dedicated icon for the drive 1200, the drive icon display device 1100 obtains the dedicated icon for the drive 1200 from the drive 1200. This makes it possible that, even if the drive 1200 is a recordable DVD/BD drive and an optimum icon corresponding to a recordable DVD/BD drive is not stored in the drive icon display device 1100, the drive icon display device 1100 displays on the screen an optimum icon for the drive 1200 which is a recordable DVD/BD drive.

As described above, the drive icon display system 1000 and the drive icon display method 100 according to the first embodiment of the present invention make it possible to display on the screen an optimum icon corresponding to the drive 1200 connected to the drive icon display device 1100, thereby enabling a user to easily specify a drive to be operated.

In addition, in a case where a new type of drive is developed in the future, the drive icon display system 1000 and the drive icon display method 100 according to the first embodiment of the present invention make it possible to display an optimum icon which represents the new type of drive even if the operating system included in the drive icon display device is not configured to support the new type of drive.

### Second Embodiment

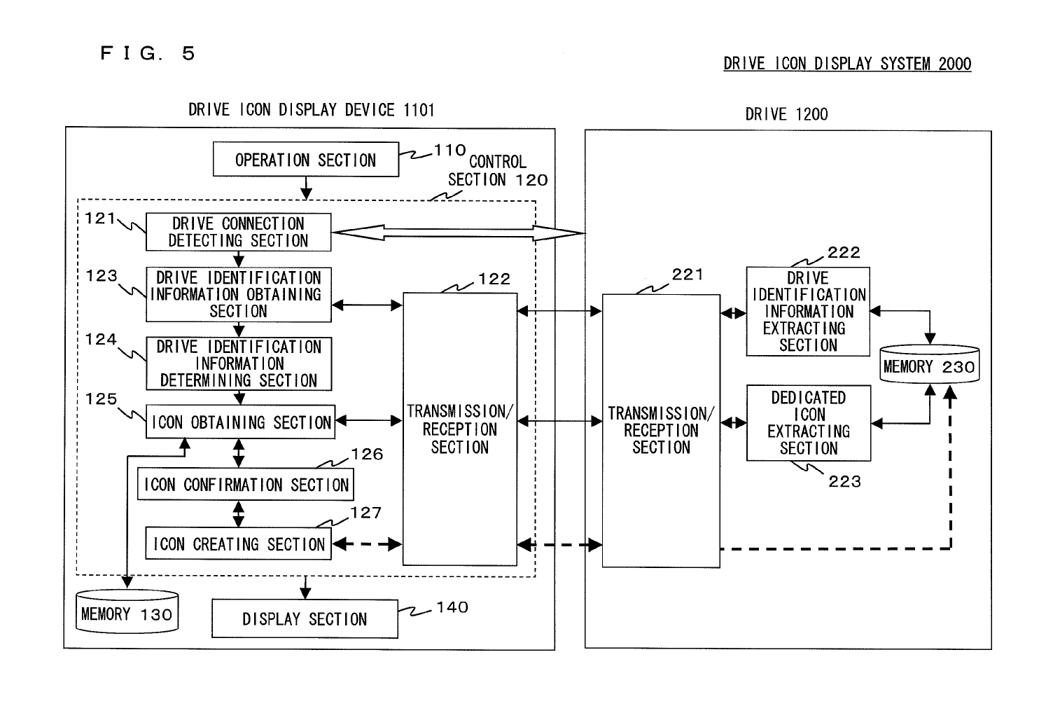

FIG. 5 shows a drive icon display system 2000 according to a second embodiment of the present invention. A basic configuration of the drive icon display system 2000 according to the present embodiment is the same as that of the drive icon display system 1000 according to the first embodiment of the present invention. The drive icon display system 2000 according to the present embodiment differs from the drive icon display system 1000 according to the first embodiment of the present invention in that a drive icon display device 1101 includes an icon confirmation section 126 and an icon creating section 127. In FIG. 5, the same components as those shown in FIG. 1 are denoted by the same reference numerals and detailed description thereof is omitted. In the present embodiment, differences from the first embodiment of the present invention will be described in detail.

In the first embodiment of the present invention, when the icon obtaining section 125 obtains the dedicated icon from the drive 1200, the drive icon display device 1100 directly displays on the screen the obtained dedicated icon. In the present embodiment, a user confirms whether to directly employ and display the dedicated icon on the screen, or to create and display on the screen a new dedicated icon different from the dedicated icon.

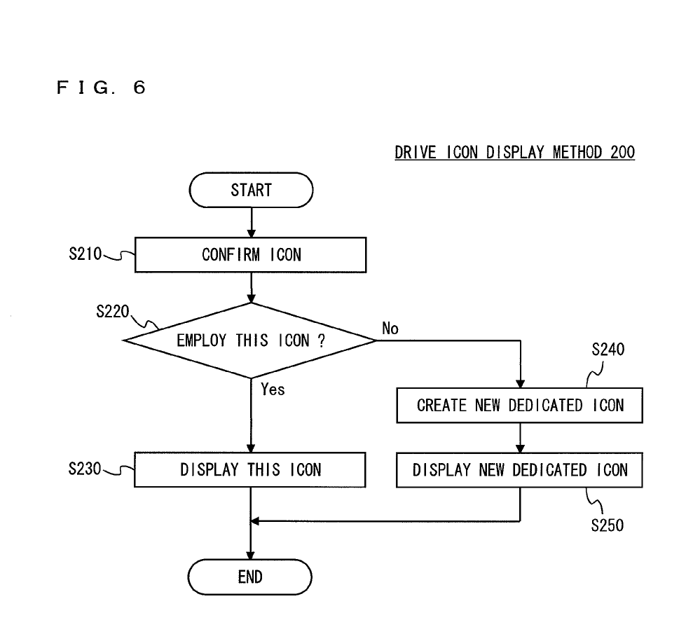

FIG. 6 is a flowchart showing a drive icon display method 200 according to the second embodiment of the present invention. The drive icon display method 200 is obtained by improving step S170, in FIG. 2, described in the first embodiment of the present invention, and is shown in detail in FIG. 6.

The drive icon display device 1101 according to the present embodiment executes steps S110 to S160 of the drive icon display method 100, shown in FIG. 2, described in the first embodiment of the present invention, and then, in step S170, executes the drive icon display method 200 shown in FIG. 6.

In step S210, the icon confirmation section 126 confirms with a user whether or not to employ the dedicated icon, by, for example, displaying on the screen the dedicated icon, for the drive 1200, obtained in step S160 in FIG. 2.

In step S220, the user determines whether or not to employ the dedicated icon which the user is requested to confirm in step S210.

If the user determines to employ the dedicated icon (Yes in step S220), the display section 140, in step 230, directly displays on the screen the dedicated icon, for the drive 1200, obtained in step S160.

On the other hand, if the user determines not to employ the dedicated icon (No in step S220), in step S240, the user operates the operation section 110, which is a mouse, a keyboard, or the like, whereby the icon creating section 127 creates a new dedicated icon for the drive 1200 connected to the drive icon display device 1101. Wherein, the new dedicated icon may be newly created, or may be created based on the dedicated icon which the user is requested to confirm. In step S250, the display section 140 displays on the screen the new dedicated icon created in step S240 instead of the dedicated icon.

Thus, after causing the user to confirm the dedicated icon for the drive 1200 which has been obtained by the drive display device 1101, the drive icon display device 1101 directly employs and displays the dedicated icon on the screen, or creates and displays on the screen a new dedicated icon different from the dedicated icon.

In a case where a dedicated icon is caused to be stored in advance in a drive by the manufacturer when the drive is manufactured, and where a plurality of same-type drives which are manufactured by the same manufacturer are connected to the drive icon display device 1101, it is supposed that the dedicated icons for the drives are identical. In this case, by creating new dedicated icons for the drives, respectively, it can be avoided that identical dedicated icons are displayed on the screen.

As described above, the drive icon display system 2000 and the drive icon display method 200 according to the second embodiment of the present invention make it possible to display on the screen an optimum icon corresponding to the drive 1200 connected to the drive icon display device 1101, thereby enabling a user to easily specify a drive to be operated.

In addition, in the drive icon display system 2000 and the drive icon display method 200 according to the second embodiment of the present invention, the user creates a new dedicated icon instead of employing the dedicated icon created in advance by the manufacturer of the drive, whereby it becomes possible to display, on the screen, optimum icons which correspond to the drives, respectively, and which can be easily specified by the user.

The new dedicated icon created in step S240 may be stored in the memory 230 of the drive 1200. If the new dedicated icon is stored in the memory 230 of the drive 1200, it becomes possible that, when the drive 1200 is connected to the drive icon display device 1101 next time, the drive icon display device 1101 obtains and displays on the screen the new dedicated icon as a dedicated icon for the drive 1200 by executing the drive icon display method 100 described in the first embodiment of the present invention.

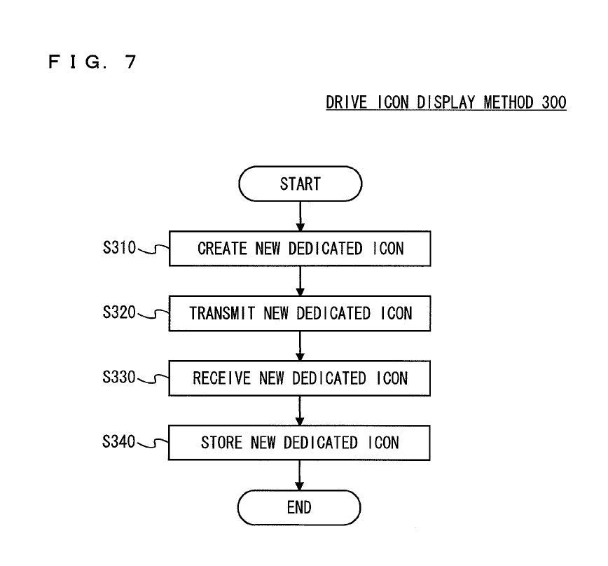

FIG. 7 is a flowchart showing the drive icon display method 300 for displaying a new dedicated icon as a dedicated icon for a drive.

The drive icon display method 300 is obtained by improving step S240 in FIG. 6, and is shown in detail in FIG. 7.

In step S310, the user operates the operation section 110, which is a mouse, a keyboard, or the like, whereby the icon creating section 127 creates a new dedicated icon for the drive 1200 connected to the drive icon display device 1101.

In step S320, the transmission/reception section 122 of the drive icon display device 1101 transmits the new dedicated icon created in step S310 to the drive 1200.

In step S330, the transmission/reception section 221 of the drive 1200 receives the new dedicated icon transmitted in step S320 from the drive icon display device 1101.

In step S340, the drive 1200 stores in the memory 230 the new dedicated icon received in step S330.

Thus, the new dedicated icon for the drive 1200 is created by the icon creating section 127 of the drive icon display device 1101, and then stored in the memory 230 of the drive 1200. When the drive 1200 is connected to the drive icon display device 1101 next time, the drive icon display device 1101 executes the drive icon display method 100 described in the first embodiment of the present invention. Wherein, the drive icon display device 1101 can obtain the new dedicated icon stored in advance in the drive 1200 (steps S150 and S160 in FIG. 2), and display the new dedicated icon on the screen (step S170 in FIG. 2).

In the present embodiment, the drive icon display device 1101 causes the user to confirm the dedicated icon obtained from the drive 1200. However, the drive icon display device 1101 may cause the user to confirm a predetermined icon obtained from the memory 130 of the drive icon display device 1101. If the drive 1200 does not store the dedicated icon, the predetermined icon is obtained from the memory 130 of the drive icon display device 1101 (step S180 in FIG. 2). In this case, the drive icon display device 1101 may confirm with the user whether to directly employ and display the predetermined icon on the screen, or to create and display on the screen a new dedicated icon different from the predetermined icon. Thus, in a case where the predetermined icon is not employed, the created new dedicated icon can be displayed on the screen instead of the predetermined icon.

Further, even if the dedicated icon is not stored in advance in a memory of a drive, a new dedicated icon created by a user can be newly stored in the memory of the drive as long as the above-described process is applicable to the drive. This makes it possible that, when the drive 1200 is connected to the drive icon display device 1101 next time, the drive icon display device 1101 obtains and displays on the screen the new dedicated icon as a dedicated icon for the drive 1200 by executing the drive icon display method 100 described in the first embodiment of the present invention.

While the invention has been described in detail, the foregoing description is in all aspects illustrative and not restrictive. It is understood that numerous other modifications and variations can be devised without departing from the scope of the invention.

What is claimed is:

1. A drive icon display device for recognizing a drive and displaying an icon of the drive, the drive icon display device comprising:
a drive connection detecting section for detecting that the drive is connected;
a drive identification information obtaining section for obtaining drive identification information which indicates a type of the drive and contains icon storage information that indicates whether or not the drive stores a dedicated icon which is a symbol representing the drive;
a drive identification information determining section for determining, based on the icon storage information, whether or not the drive stores the dedicated icon;
an icon obtaining section for, when it is determined that the drive stores the dedicated icon, obtaining the dedicated icon from the drive, and for, when it is determined that the drive does not store the dedicated icon, obtaining a predetermined icon corresponding to the type of the drive from among icons stored in advance in the drive icon display device; and
a display section for displaying on a screen one of the obtained dedicated icon and the obtained predetermined icon.

2. The drive icon display device according to claim 1, further comprising:
an icon confirmation section for causing a user to confirm whether or not to employ the obtained dedicated icon; and
an icon creating section for, based on the result of the confirmation in the icon confirmation section, when the dedicated icon is not employed, creating a new dedicated icon different from the dedicated icon,
wherein the display section displays on the screen the new dedicated icon instead of the dedicated icon.

3. The drive icon display device according to claim 2, wherein the created new dedicated icon is provided to the drive.

4. A drive icon display method for displaying an icon of a drive recognized by a drive icon display device, the method executing:
a drive connection detecting step of detecting that the drive is connected;
a drive identification information obtaining step of obtaining drive identification information which indicates a type of the drive and contains icon storage information that indicates whether or not the drive stores a dedicated icon which is a symbol representing the drive;
a drive identification information determining step of determining, based on the icon storage information, whether or not the drive stores the dedicated icon;
an icon obtaining step of, when it is determined that the drive stores the dedicated icon, obtaining the dedicated icon from the drive, and of, when it is determined that the drive does not store the dedicated icon, obtaining a predetermined icon corresponding to the type of the drive from among icons stored in advance in the drive icon display device; and
a display step of displaying on a screen one of the obtained dedicated icon and the obtained predetermined icon.

5. The drive icon display method according to claim 4, further executing:
an icon confirmation step of causing a user to confirm whether or not to employ the obtained dedicated icon; and
an icon creating step of, based on the result of the confirmation in the icon confirmation step, when the dedicated icon is not employed, creating a new dedicated icon different from the dedicated icon,
wherein the display step displays on the screen the new dedicated icon instead of the dedicated icon.

6. The drive icon display method according to claim 5, further executing an icon providing step of providing the created new dedicated icon to the drive.

7. A drive icon display system comprising a drive and a drive icon display device for recognizing the drive and displaying an icon of the drive, wherein
the drive includes:
a memory for storing drive identification information which indicates a type of the drive and contains icon storage information that indicates whether or not the drive stores a dedicated icon which is a symbol representing the drive, and for storing the dedicated icon;
a drive identification information extracting section for, based on a request for drive identification information from the drive icon display device, extracting from the memory the drive identification information about the drive; and
a dedicated icon extracting section for, based on a request for a dedicated icon from the drive icon display device, extracting from the memory the dedicated icon for the drive, and
the drive icon display device includes:
a drive connection detecting section for detecting that the drive is connected;
a drive identification information obtaining section for making a request to the drive for the drive identification information, and obtaining the drive identification information;
a drive identification information determining section for determining, based on the icon storage information, whether or not the drive stores the dedicated icon;
an icon obtaining section for, when it is determined that the drive stores the dedicated icon, making a request to the drive for the dedicated icon and obtaining the dedicated icon, and for, when it is determined that the drive does not store the dedicated icon, obtaining a predetermined icon corresponding to the type of the drive from among icons stored in advance in the drive icon display device; and
a display section for displaying on a screen one of the obtained dedicated icon and the obtained predetermined icon.

8. The drive icon display system according to claim 7, wherein
the drive icon display device further includes:
an icon confirmation section for causing a user to confirm whether or not to employ the obtained dedicated icon; and
an icon creating section for, based on the result of the confirmation in the icon confirmation section, when the dedicated icon is not employed, creating a new dedicated icon different from the dedicated icon, and
the display section displays on the screen the new dedicated icon instead of the dedicated icon.

9. The drive icon display system according to claim 8, wherein
the drive icon display device provides the created new dedicated icon to the drive, and
the drive stores in the memory the new dedicated icon provided by the drive icon display device.
